(19) United States
(12) Patent Application Publication
(10) Pub. No.: US 2007/0036898 A1
(43) Pub. Date: Feb. 15, 2007

(54) Apparatus for mixing and/or applying a cementitious product and related method

(76) Inventors: Jared M. Hill, Sandy, UT (US); Brittany Davis, Genola, UT (US); Philip Evans, Hutchinson, MN (US); Isaac Hart, Spring, TX (US); Jason Huntsman, Ogden, UT (US); Will Mickelson, Leominster, MA (US); Mark Spencer, Salt Lake City, UT (US); Johnny M. Trevino, Richland, WA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/202,821

(22) Filed: Aug. 12, 2005

(51) Int. Cl. B05D 5/00; B05C 5/00

(52) U.S. Cl. 427/256; 118/300

(57) ABSTRACT

An apparatus and related method for mixing and/or applying a cementitious product. The apparatus includes a container for holding a cementitious product, a pump for delivering the cementitious product from the container to an applicator head, and an applicator head for shaping and applying the cementitious product to a surface so as to have a desired thickness and contour.

### BACKGROUND OF THE INVENTION

1. The Field of the Invention

The present invention generally relates to the field of mixing and applying cementitious products (e.g., a tile mortar adhesive or grout) for commercial and residential construction projects.

2. The Relevant Technology

The difficult and time consuming task of laying tile is often a part of commercial and residential construction projects. Much of the labor intrinsic to tiling projects involves the preparation and application of mortar used to bond the tile to the application surface. One type of tile adhesive mortar, known as “thinset” is a fine grained powder cement, typically provided in the form of 50 pound bags. To prepare the thinset, the user first combines a desired amount of powder cement with water in a container (e.g., a five gallon bucket) according to the manufacturer's prescribed ratio. A drill attachment similar to an egg beater is then attached to a high power drill to mix the thick mortar mixture. Once the powder and water have been adequately mixed, the mixture is allowed to sit undisturbed for a ten minute slaking period, after which the mixture may be mixed again.

Once properly prepared, the tile mortar adhesive is applied to the tiling surface using a hand trowel. When applying the mortar to a floor surface to be tiled (which is the most common application), the worker must crouch down on all fours, which can be particularly uncomfortable on the person's knees and other joints. One side of the trowel surface is contoured by uniformly spaced square grooves with depths ranging from about ⅜ to ½ inch depending on the thickness of the mortar required for a particular application. The grooves create a series of mountains and valleys in the thin layer of mortar such that when the tile is laid down, the mortar flattens and seeps into the bonding matrix formed on the tile's back side.

The more common slower setting mortars require the user to return at least a day later to apply grout over the tiled surface. Recently, new rapid-setting mortars have been introduced to the market, which do not require a slaking period, and which allow a user to apply grout over a tiled surface on the same day that the tile is laid. Although available, these new rapid-setting mortars have not found widespread use because it has been difficult with current techniques and tools to apply the mortar and lay the tile before the rapid-setting mortar becomes partially cured and too stiff to work with.

In light of the aforementioned difficulties, it would be an improvement in the art to provide an apparatus and related method that would simplify the preparation and application of tile mortar adhesive (and/or grout). In addition, it would be a further improvement to provide an apparatus and method that would speed up the mortar preparation, application, and tile laying process so as to allow a user to use the recently available rapid-setting mortar adhesives.

### SUMMARY OF THE INVENTION

The present invention is directed to an apparatus and related method for applying a cementitious product (e.g., a tile mortar adhesive, grout, cement, plasterboard mud). The apparatus includes a container for holding a cementitious product, a pump for delivering the cementitious product from the container to an applicator head, a passageway (e.g., tubing) between the pump and the applicator head, and an applicator head for shaping and applying the cementitious product to a surface so as to have a desired thickness and contour.

The apparatus may be assembled on a frame. The frame may be a light weight portable frame which may include a wheel or wheels that allow the apparatus to be easily portable and operable by one person. In one example, the apparatus may weigh less than about 75 pounds empty. In addition, the apparatus may be configured to operate on a standard 110 volt power outlet. Such features make the apparatus particularly suitable for relatively small jobs (e.g., most residential work), while also providing for simple operation of the apparatus.

In one embodiment of the apparatus, the container comprises a mixing chamber for mixing a dry powder with a liquid to form a cementitious product (e.g., mortar or grout). The apparatus may further include a hopper, which may also be supported on the frame and which is in communication with the mixing chamber. The hopper may be configured to hold a dry powder. The hopper may include an auger for selectively delivering dry powder to the mixing chamber. In addition, the apparatus may further include a water storage container, also supported on the frame, and associated tubing for selectively delivering water to the mixing chamber for preparation of a cementitious product.

The apparatus may include a control system so as to allow maintenance of a desired dry powder to water ratio. In one embodiment, such a control system may meter at least one of the dry powder or the water delivered to the mixing chamber for preparation of the cementitious product. Such metering allows the apparatus to control the flow rate of the dry powder and/or water, and shut off the flow of one or the other, as needed.

The present invention also relates to a method for mixing and applying a cementitious product. An apparatus (e.g., as described above) is provided, and used to mix a dry powder with water to form a cementitious product (e.g., a mortar tile adhesive or grout). The apparatus is then used to pump and apply the product to a surface to be tiled (e.g., a floor or a wall). The applicator head of the apparatus allows the product to be applied so as to have a desired thickness and contour. If applying a tile mortar adhesive, the surface is then ready for application of the tile over the contoured mortar.

These and other benefits, advantages and features of the present invention will become more full apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1A illustrates two perspective views of an exemplary apparatus for both mixing and applying a cementitious product;

FIG. 1B illustrates a side view of the apparatus of FIG. 1A;

FIG. 1C is a flow diagram describing the function and relation of components included in an exemplary apparatus;

FIG. 2 illustrates the internal components of the exemplary apparatus of FIG. 1A;

FIG. 3 illustrates a perspective view of an exemplary hopper and auger included in the apparatus of FIG. 2;

FIG. 4A illustrates a partial cut away perspective view of the water container and mixing chamber of the apparatus of FIG. 2;

FIGS. 4B-4D illustrate perspective views of several exemplary mixing members;

FIG. 5 illustrates a partial cut away perspective view of an exemplary pump and delivery tube included in the apparatus of FIG. 2;

FIGS. 6A-6B illustrate alternative applicator heads that may be interchangeably connected to the distal end of the delivery tube of the apparatus of FIG. 1A;

FIG. 7 illustrates an exemplary control system diagram that may be used with the exemplary apparatus; and

FIG. 8 illustrates an operator using the apparatus of FIG. 1A to apply a layer of tile adhesive mortar to a surface to be tiled.

### DETAILED DESCRIPTION OF THE PREFERRED EMBODIMENTS

I. Introduction

A detailed description of various exemplary embodiments will now be provided with specific reference to the above mentioned Figures. It will be appreciated that like structures will be provided with like reference designations.

II. An Exemplary Apparatus

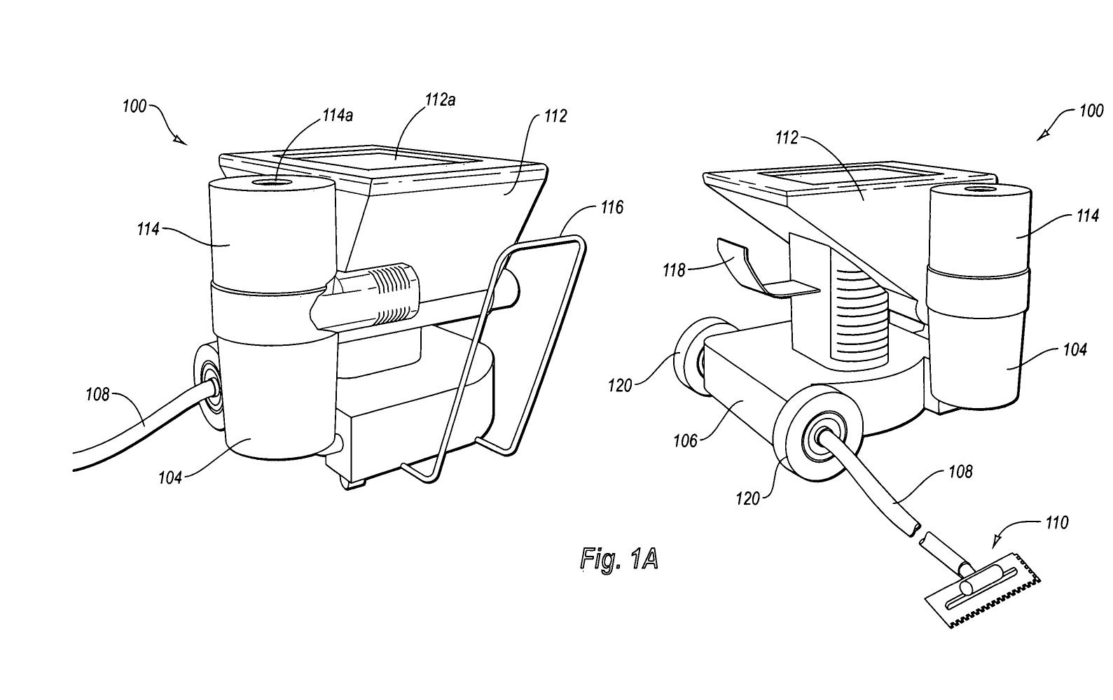

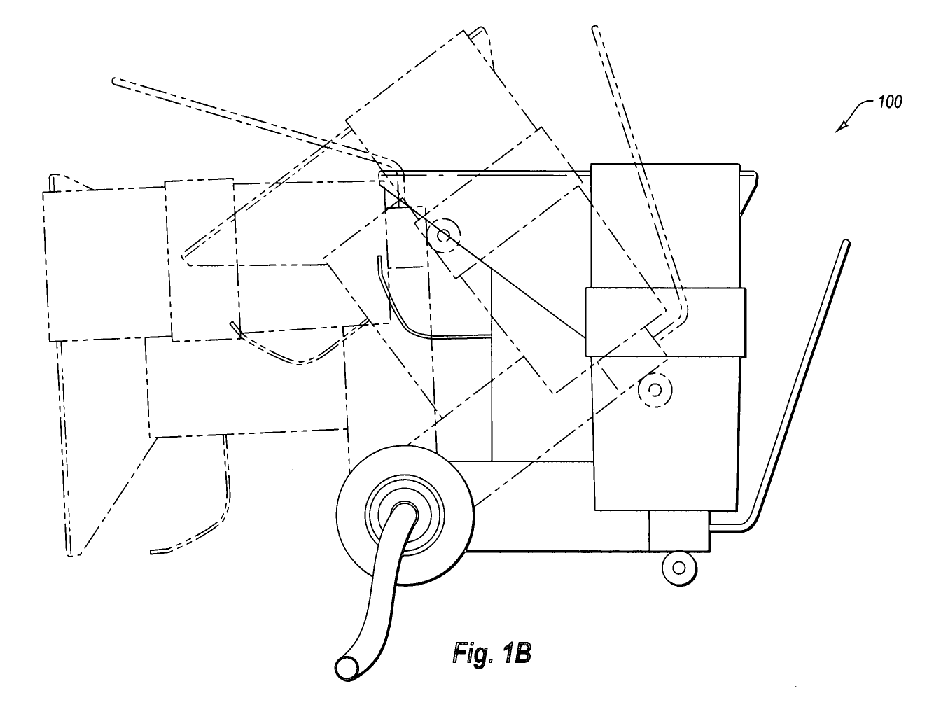

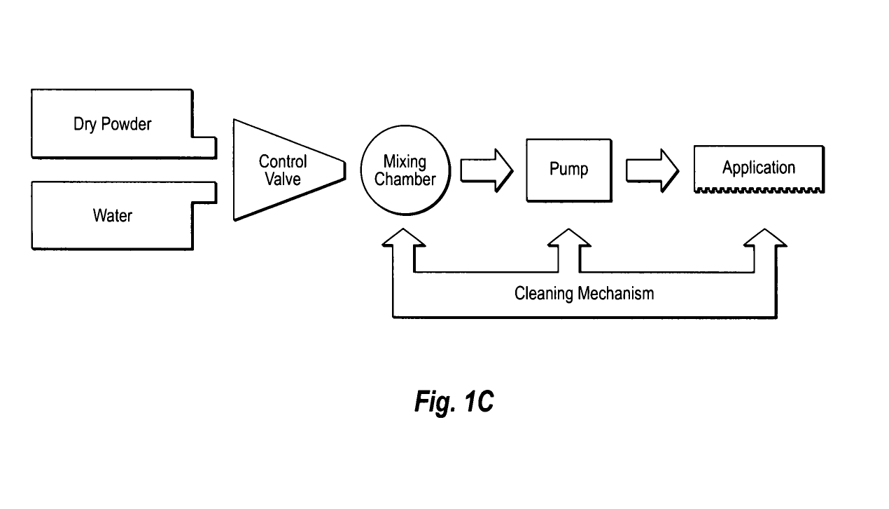

FIG. 1A illustrates two perspective views of an exemplary apparatus 100. Apparatus 100 may include a frame (e.g., including a housing), a mixing chamber 104, a pump 106, a passageway (e.g., tubing 108), and an applicator head 110. The illustrated apparatus 100 also includes a hopper 112 for containing dry powder, and a water storage container 114. The components of the apparatus, including mixing chamber 104, pump 106, hopper 112, and container 114 may be supported on a frame.

Hopper 112 includes a cover 112a, which may be hingedly connected to the top of the hopper for conveniently allowing a user to fill the hopper with dry powder. The cover 112a also tends to prevent any dust that might otherwise be produced from the dry powder within hopper 112 from escaping hopper 112.

Water storage container 114 also includes a cover, having an opening 114a located near the top of the apparatus for conveniently allowing a user to fill container 114 with water. Opening 114a may include a cap (e.g., a screw on cap), if desired.

The illustrated exemplary apparatus 100 also includes a handle 116, a hose support 118, and wheels 120. Handle 116 and wheels 120 allow the light weight apparatus 100 to be easily maneuvered as needed by a single user, while hose support 118 allows the user to support a desired length of hose 108 either during use, or for storage. Tubing 108 of the illustrated embodiment is configured such that tubing 108 exits pump 106 through the center of wheel 120. Such an embodiment minimizes instances of the wheel encountering tubing 108 as an obstacle during movement of the apparatus. FIG. 1B illustrates a side view of the apparatus 100 and illustrates in phantom how the apparatus 100 may be tipped so as to be supported on hose support 118. In addition to flexibility of operation, this arrangement allows for easy access and cleaning of the pump 106, located near the bottom of apparatus 100.

FIG. 1C is a flow diagram describing the function and relation of components included within the exemplary apparatus. Dry powder is combined with water, either or both of which may be metered through a control valve. The dry powder and water are delivered into a mixing chamber where they are mixed to form a cementitious product. The mixed product is then delivered to a pump which is then delivered through tubing to an applicator head. The apparatus may include means for cleaning the mixing chamber, the pump, the tubing and the applicator head once a user has finished using the apparatus. In one example, water may simply be fed through the system to clean out any residual material.

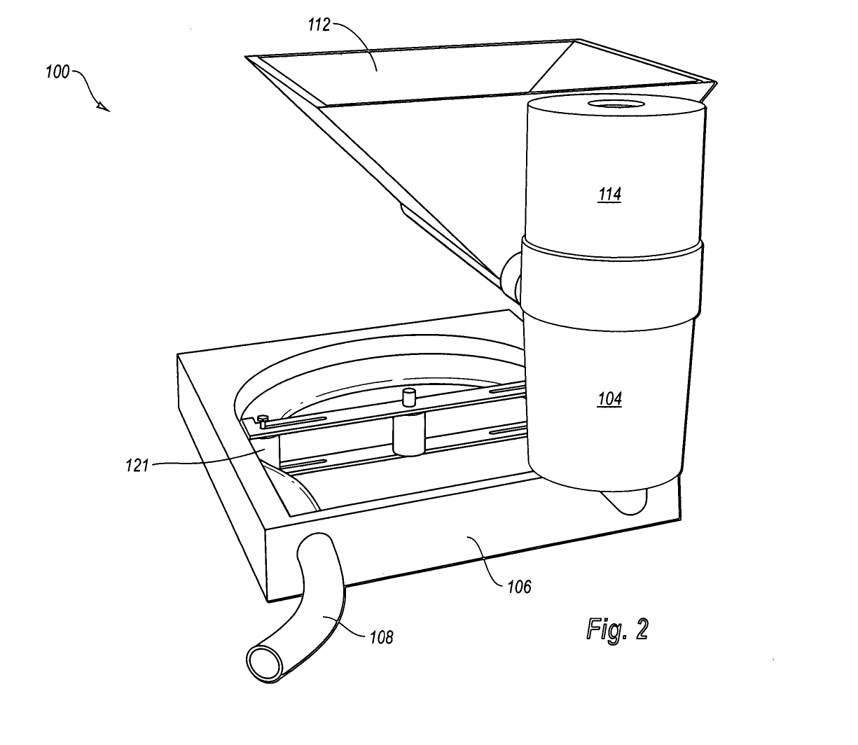

FIG. 2 illustrates a partial internal view of the apparatus with parts of the housing removed so as to more clearly show hopper 112, mixing chamber 104, water container 114, pump 106 and hose 108. Dry powder material from hopper 112 is delivered into mixing chamber 104 along with water from water container 114. The dry powder and water are mixed in mixing chamber 104 by any suitable mixing member (e.g., a paddle). Thus, mixing chamber 104 is one example of a container for holding a cementitious product. The mixed product then leaves mixing chamber 104 through an outlet (e.g., formed near the bottom of mixing chamber 104) and enters hose 108 which passes through pump 106. The illustrated pump 106 is a peristaltic pump which includes rotating rollers 121 that act on flexible hose 108 so as to push the mixed product through the hose 108 towards application head 110.

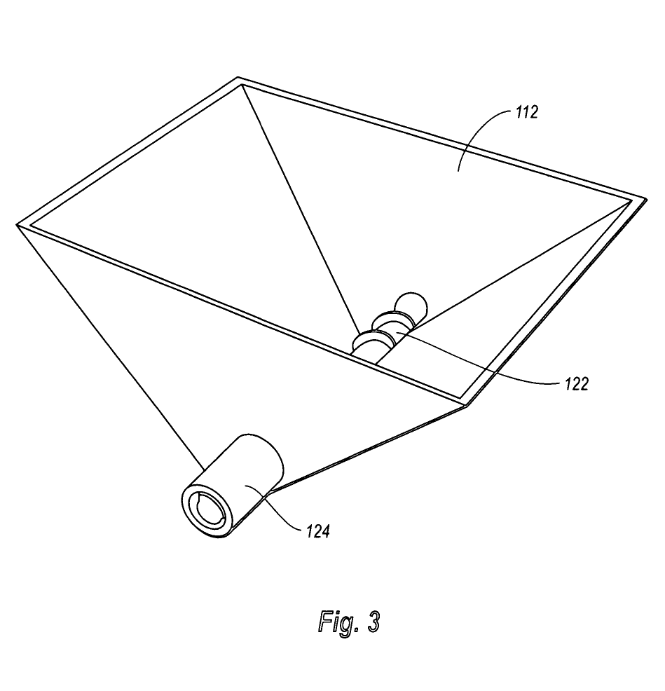

FIG. 3 shows a hopper 112 having an auger 122 located within hopper 112. In the illustrated embodiment, auger 122 is located at the bottom of hopper 112 and is selectively operable to deliver a metered amount of dry powder out of hopper 112 through outlet 124, which is in communication with mixing chamber 104. Auger 122 may be formed from any suitable material. Nylon may be preferred in some embodiments because of its light weight and high resistance to abrasion. The auger may be powered by any suitable motor. A ¾ HP motor operated at about 320 RPM and less was found to be capable of providing about 2 gallons per minute of powder flow to the mixing chamber, which was enough to produce enough mixed tile mortar adhesive to cover about 20 ft²/min of surface to be tiled.

The hopper 112 may be formed by thermoforming an acrylonitrile-butadiene-styrene (ABS) material into the desired shape. The illustrated hopper 112 includes two substantially vertical side walls and two additional side walls sloped at approximately 45°. This is one example of a hopper configuration that promotes powder flow without bridging or clogging of the powder. One exemplary hopper 112 is formed so as to have a volume of about 1.4 ft³. It is to be understood that other materials, manufacturing methods, and hopper sizes and shapes may alternatively be employed, as desired.

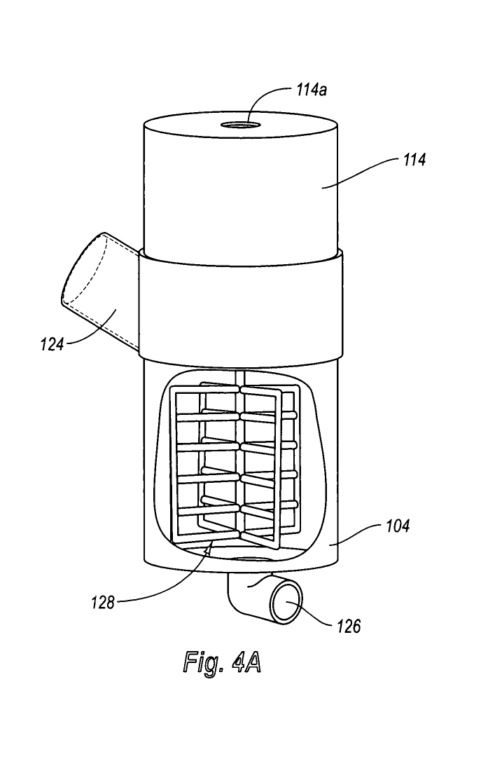

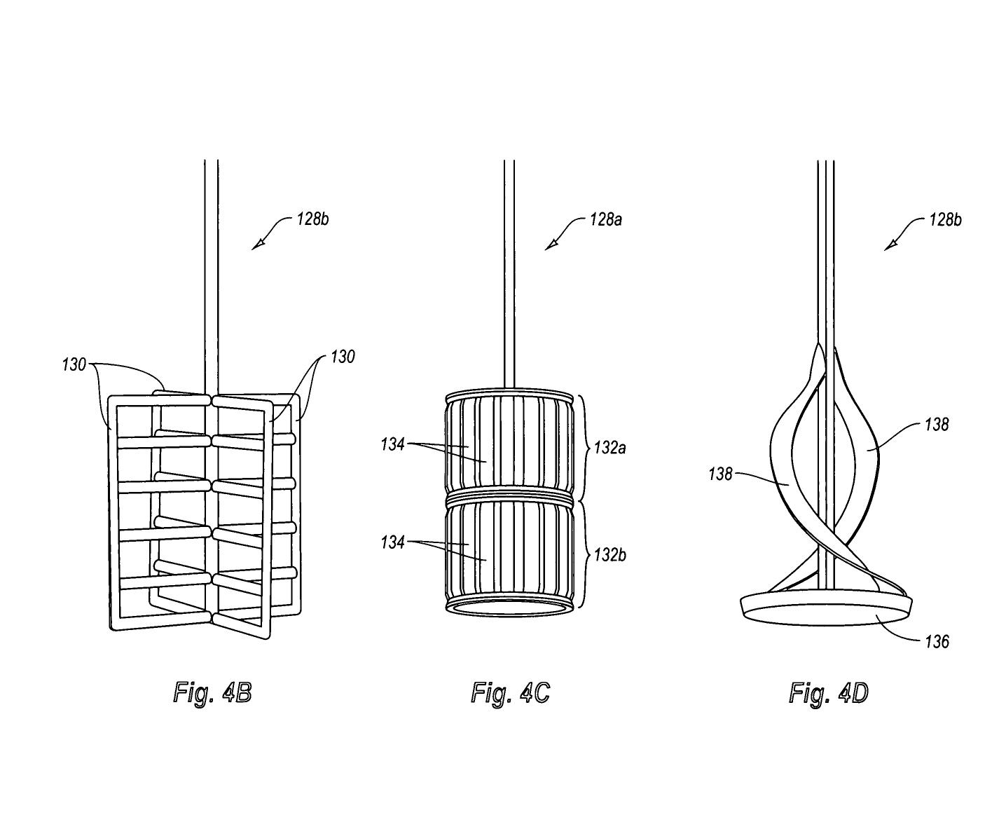

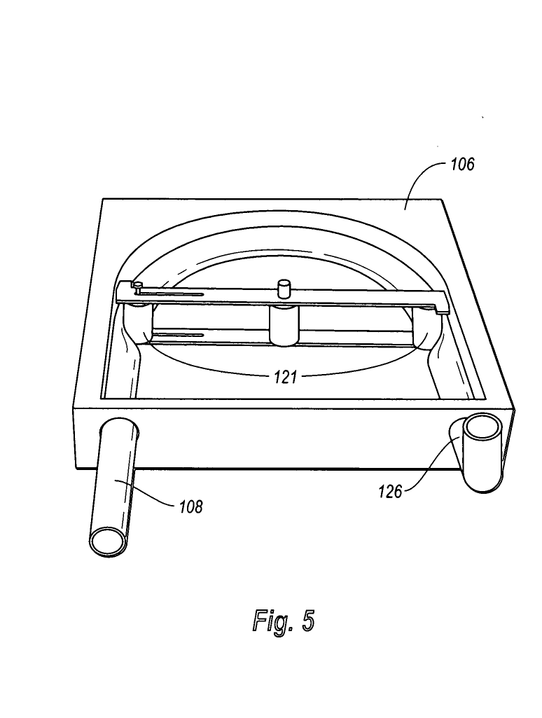

FIG. 4A illustrates mixing chamber 104 and water container 114. The illustrated 266 embodiment is situated such that water chamber 114 is positioned directly above mixing chamber 104. Dry powder enters mixing chamber 104 through inlet 124 while water from water container 114 is metered from directly above and into mixing chamber 104. As can be seen in the cutaway portion of mixing chamber 104, a mixing member 128 may be rotated or otherwise manipulated to agitate and mix the dry powder and water being introduced into mixing chamber 104. The mixed product exits mixing chamber 104 through outlet 126 through which it is introduced into tube 108 and pump 106.

Water container 114 may be sized so as to have a volume of about 1 gallon. The water container may include a water pump (e.g., located at the bottom interior of water container 114) and an associated solenoid for metering the flow rate of water delivered to mixing chamber 104.

The mixing chamber 104 may be sized so as to have a volume of about 2 gallons. Mixing chamber 104 may further include a replaceable or disposable liner placed inside mixing chamber 104. Such a liner may be useful for cleaning, allowing the user to simply remove the liner either for disposal or easy cleaning.

Mixing member 128 may be configured for operation in any desired manner. One embodiment may be configured to move mixing member in a simple rotary motion, while another embodiment may be configured to move the mixing member in an epicyclic planetary motion. Another alternative may include a mixing member that moves vertically (up and down) or horizontally (back and forth). The mixing member is connected to any suitably sized motor. One embodiment of the mixing chamber and mixing member provides sufficient mixing within about 15 seconds. Other mixing member configurations for efficiently mixing the dry powder and water within the mixing chamber will be apparent to those skilled within the art.

FIGS. 4B through 4D illustrate exemplary embodiments of some suitable mixing members. FIG. 4B illustrates a mixing member 128 including vertically oriented paddles 130. FIG. 4C illustrates an alternative mixing member 128a including two stages 132a and 132b, each stage including a plurality of vertically oriented blades 134, while FIG. 4D illustrates another alternative mixing member 128b including a flat disc 136 and a plurality of helical blades 138.

FIG. 5 illustrates a cutaway perspective view of an exemplary peristaltic pump 106 and tubing 108. Exemplary pump 106 is a peristaltic pump, although other pump types may be used. A peristaltic pump may be particularly advantageous in that no moving parts of the pump come in contact with mixed product being pumped for delivery and application. Among other advantages, this makes pump 106 particularly easy to clean and less prone to damage or failure that might otherwise occur. The mixed product is introduced into tube 108 at pump inlet 126. Rollers 121 of pump 106 are rotated at a desired rate in order to compress the flexible tubing 108 and push the mixed product towards a distal end of tubing 108 and applicator head 110. When using a peristaltic pump, tubing 108 may be formed of any suitable flexible material (e.g., latex or natural rubber). One suitable peristaltic pump is available from the Randolph-Austin Company, located in Austin, Tex.

Pump 106 and tubing 108 comprise structure corresponding to delivery means for pumping and delivering the product from chamber 104 to applicator head 110. Any other pump may also comprise delivery means for pumping and delivering product from chamber 104 to applicator head 110.

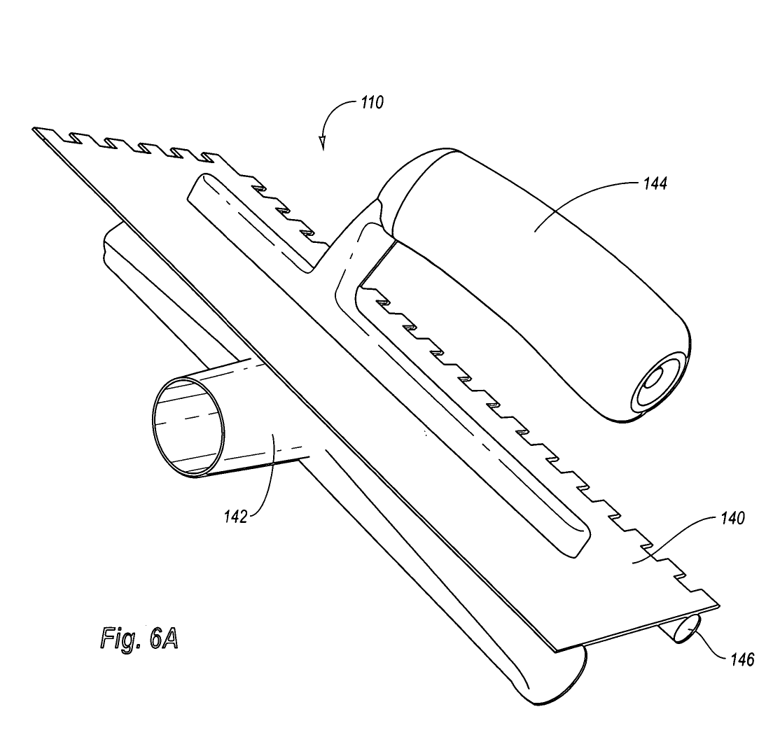

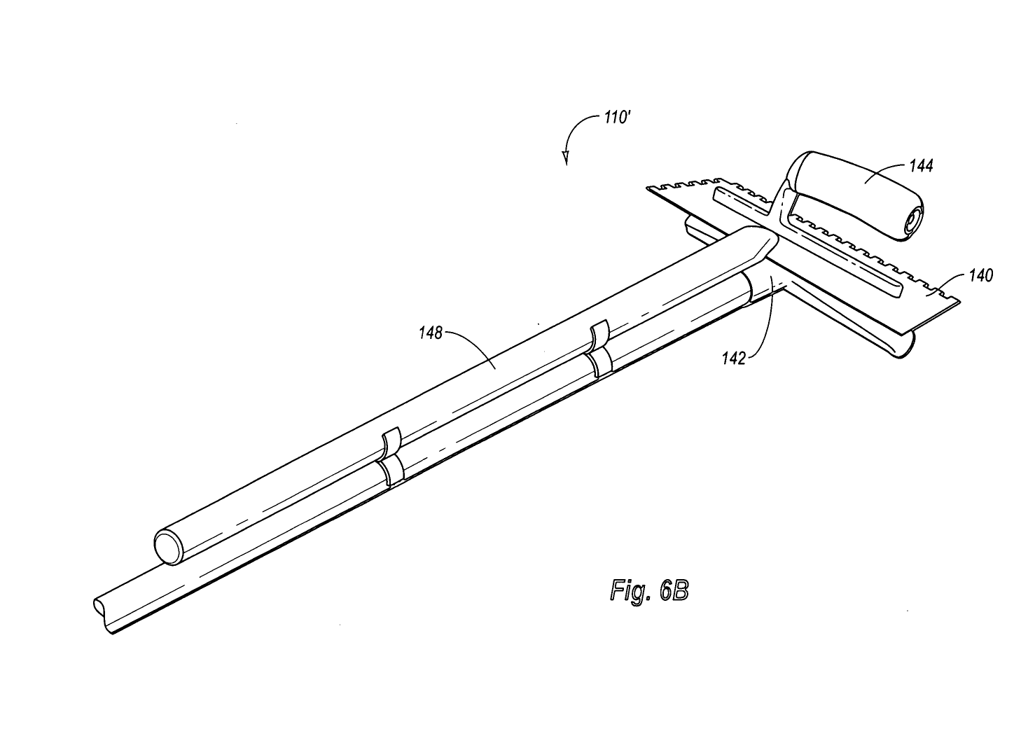

FIG. 6A illustrates one embodiment of an applicator head 110 which includes a blade 140, a coupler 142 for connecting to tube 108, and an optional grip member 144. In one example, blade 140 is configured to be at about 45° relative to the application surface. The blade may include an edge for giving the applied material any desired texture. In one embodiment, the blade includes grooves having depths of about ⅜ to about ½ inch. As illustrated, coupler 142 may be configured to spread the mixed product along substantially the entire length of blade 140, allowing the user to use the full length of blade 140 to apply and contour the applied product. Applicator head 110 may further include one or more rollers 146 which may be connected to the control system of apparatus 100. In one example, the rate of mixing and delivery of mixed product is regulated by the rate at which the user rolls the applicator head 110 along the application surface. In another example (not shown), the applicator head may include a trigger (e.g., near grip 144) that activates delivery of the mixed product.

FIG. 6B illustrates an alternative applicator head 110′ similar to that illustrated in FIG. 6A, but also including a handle 148 (e.g., a 5′ pole) such a handle allows a user to apply the mixed product to a desired surface (e.g., a floor or a wall) such that the applied product has a desired thickness and contour without requiring the user to be down on his knees on the floor. In other words, the user may stand while conveniently applying the mixed product. In one embodiment (not shown) the elongate handle 148 may comprise a section of rigid tubing coupleable to tubing 108, such that a separate handle 148 is not required. Such an embodiment may be less bulky and easier to maneuver and operate. The applicator head may comprise any structure attached near an end of tubing 108 (or other passageway) capable of shaping and applying the cementitious product to a desired surface (e.g., a floor or wall). The applicator head shapes the cementitious product by imposing a desired thickness and contour on the cementitious product such that after the cementitious product is delivered to the surface, it has the desired thickness and contour.

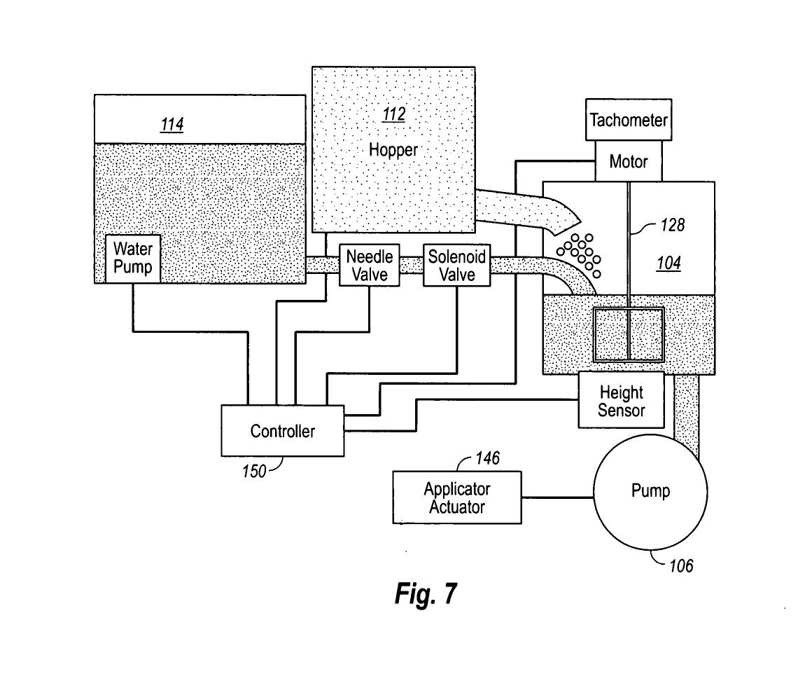

FIG. 7 illustrates a diagram of an exemplary control system for controlling the components of exemplary apparatus 100. The apparatus may include four motors: a water pump associated with water storage container 114, a motor associated with hopper 112 and auger 121, a motor associated with pump 106, and a motor associated with mixing chamber 104 and mixing member 128. These various motors may be managed by a system control board 150. In order to prevent premature curing of the mixed material, the motor associated with the mixing chamber 104 and mixing member 128 may be configured to run whenever the apparatus is switched on. As illustrated in FIG. 7, mixing chamber 104 may include a height sensor (e.g., an infrared height sensor). When the volume of material within mixing chamber 104 drops below a desired value, the controller may activate auger 121 to deliver more dry powder to mixing chamber 104 and a water pump within water storage container 114 to deliver more water to mixing chamber 104. A water valve and solenoid associated with water storage container 114 may meter the water and shut off the water once the desired ratio of powder to water has been reached.

A tachometer sensor associated with the mixing member 128 and its motor may be used to measure the rotational velocity of the mixing member 128. When the mixing member 128 slows down (mixture too thick) at a given mixing chamber volume (measured by e.g., an infrared height sensor), the controller may activate the water pump. When the mixing member slows down (mixture too thin) at a given mixing chamber volume, the controller may activate the auger 121 to deliver more dry powder. Although one particular control system has been described, it is to be understood that the use of a control system is not limited to this configuration, and that other configurations may alternatively be used.

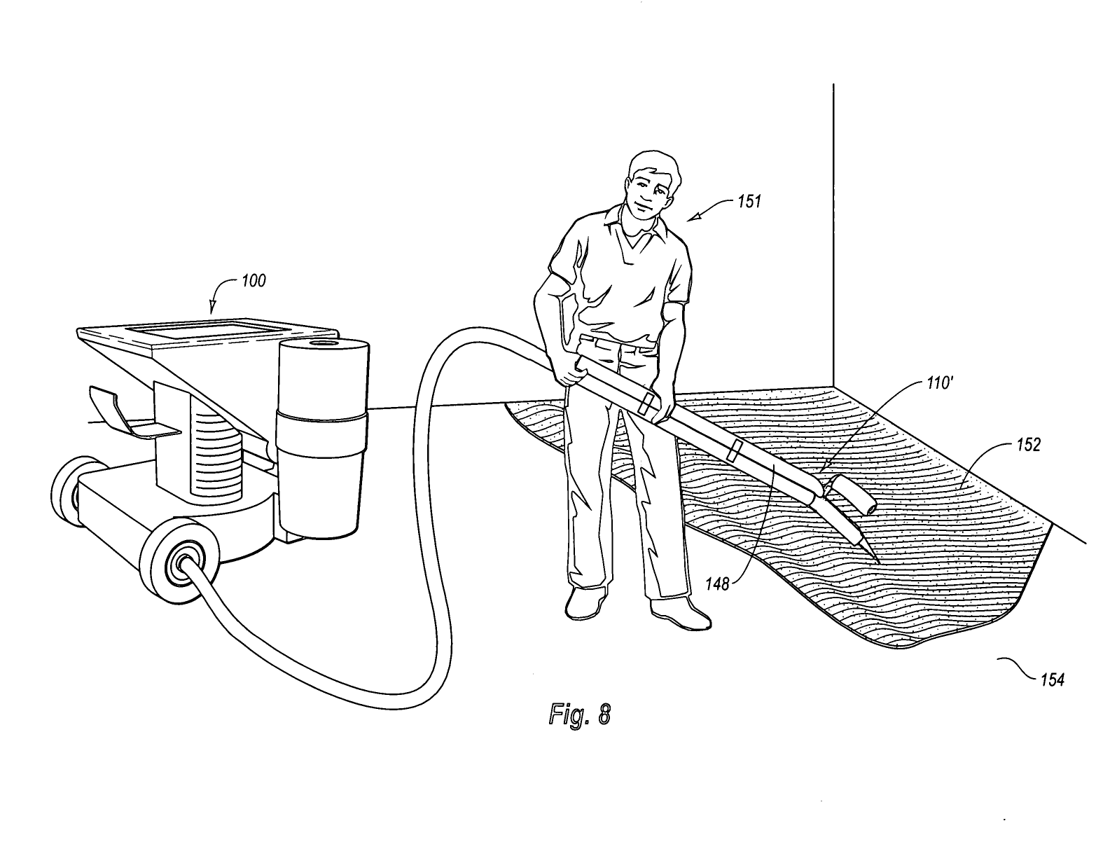

FIG. 8 illustrates a user 151 using apparatus 100 with applicator head 110′. Apparatus 100 is used to mix a dry powder with water to form a mortar tile adhesive 152. The apparatus 100 is then used to pump and apply the product 152 to an application surface 154. The applicator head 110′ of the apparatus 100 allows the product to be applied so as to have a desired thickness and contour. The illustration shows a tile mortar adhesive 152 being applied, after which the surface will be ready for application of tile over the contoured mortar. It is to be understood that the apparatus may also be used to mix and then apply grout over the application surface 154 once the mortar 152 has sufficiently cured and the tile laid. When using a rapid-setting mortar, this may be as soon as the same day that the tile was laid.

It will be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. An apparatus for applying a cementitious product to a surface comprising:
a container for holding a cementitious product;
a passageway leading from the container to an applicator head connectable to the end of the passageway;
a pump for delivering the cementitious product from the container through the passageway to the applicator head;
the applicator head being configured to shape the cementitious product as it is delivered onto the surface such that the applicator head imposes a desired thickness and contour on the cementitious product such that after the cementitious product is delivered onto the surface it has the desired thickness and contour.

2. An apparatus as recited in claim 1, wherein the passageway comprises tubing between the container and the applicator head.

3. An apparatus as recited in claim 2, wherein the tubing is flexible.

4. An apparatus as recited in claim 1, wherein the pump comprises a peristaltic pump.

5. An apparatus as recited in claim 1, wherein the applicator head comprises:
a blade for shaping the cementitious product; and
a coupler for delivering the cementitious product from the passageway to the blade.

6. An apparatus as recited in claim 1, wherein the container comprises a mixing chamber for mixing a dry powder with a liquid to form a cementitious product.

7. An apparatus as recited in claim 1, further comprising at least one wheel.

8. An apparatus as recited in claim 7, wherein the passageway comprises tubing for delivering the cementitious product from the container through the tubing to the applicator head, and wherein the tubing passes through the wheel.

9. An apparatus as recited in claim 1, wherein the apparatus weighs less than about 75 pounds so as to be easily portable by a single person.

10. An apparatus as recited in claim 1, wherein the cementitious product comprises one of tile mortar adhesive, grout, cement or plasterboard mud.

11. An apparatus for mixing and applying a cementitious product comprising:
a mixing chamber for mixing a dry powder with a liquid to form a cementitious product;
a passageway leading from the mixing chamber to an applicator head connectable to the end of the passageway;
a pump for delivering the cementitious product from the mixing chamber through the passageway to an applicator head and onto a surface;
the applicator head being configured to shape the cementitious product as it is delivered onto the surface such that the applicator head imposes a desired thickness and contour on the cementitious product such that after the cementitious product is delivered onto the surface it has the desired thickness and contour.

12. An apparatus as recited in claim 11, further comprising a hopper in communication with the mixing chamber for holding a dry powder and an auger within the hopper for selectively delivering a dry powder to the mixing chamber.

13. An apparatus as recited in claim 12, further comprising a water storage container and associated tubing for selectively delivering water to the mixing chamber.

14. An apparatus as recited in claim 13, further comprising a control system for metering at least one of the dry powder delivered from the hopper to the mixing chamber or the water delivered from the water storage container to the mixing chamber such that a desired dry powder to water ratio is maintained.

15. An apparatus as recited in claim 14, wherein the control system includes a sensor associated with the mixing chamber for monitoring the volume of mixed cementitious product within the mixing chamber.

16. An apparatus as recited in claim 14, wherein the control system includes a sensor for monitoring the flow of water from the water storage container to the mixing chamber.

17. An apparatus as recited in claim 14, wherein the control system allows a user to select the ratio of dry powder to water.

18. A method of mixing and applying a cementitious product comprising:
mixing a dry powder with a liquid to form a cementitious product;
pumping the cementitious product through a passageway to an applicator head; and
using the applicator head to apply the cementitious product to a desired surface, the applicator head shaping the cementitious product so as to impose a desired thickness and contour on the cementitious product such that after the cementitious product is delivered to the surface it has the desired thickness and contour.

19. A method as recited in claim 18, wherein the cementitious product comprises a tile mortar adhesive, and further comprising the step of laying tile over the applied tile mortar adhesive.

20. A method as recited in claim 18, wherein the cementitious product comprises a rapid-setting tile mortar adhesive which does not require a slaking period subsequent to initial mixing.
